(19) United States
(12) Patent Application Publication
(10) Pub. No.: US 2011/0129275 A1
(43) Pub. Date: Jun. 2, 2011

(54) MEDIA TRANSPORT SYSTEM FILTER MECHANISM

(76) Inventors: Brian J. Joseph, Spencerport, NY (US); Randy E. Armbruster, Rochester, NY (US); Christopher M. Muir, Rochester, NY (US)

(21) Appl. No.: 12/627,061

(22) Filed: Nov. 30, 2009

(51) Int. Cl. B41J 15/00

(52) U.S. Cl. 400/611

(57) ABSTRACT

A digital printing system for printing on a continuous web of print media includes a support structure that guides a continuous web of print media under tension through the printing system. The continuous web of print media includes an edge. The support structure includes a first mechanism, a filter mechanism, and a section in which cross track motion of the continuous web of print media is not desired. The first mechanism is affixed to the support structure and includes structure that positions the print media in a cross track direction. The filter mechanism sets an angular trajectory of the print media, is located downstream relative to the first mechanism, and passively filters fluctuations in position of the edge of the continuous web of print media. The section in which cross track motion of the continuous web of print media is not desired is located downstream relative to the filter mechanism.

### CROSS REFERENCE TO RELATED APPLICATIONS

Reference is made to commonly-assigned copending U.S. patent application Ser. No. ______ (Docket No. 95529) filed ______ entitled “MODULAR MEDIA TRANSPORT SYSTEM”, by DeCook et al.; to commonly-assigned copending U.S. patent application Ser. No. ______ (Docket No. 95526) filed ______ entitled “MEDIA TRANSPORT SYSTEM FOR NON-CONTACTING PRINTING”, by Muir et al.

### FIELD OF THE INVENTION

The present invention generally relates to printing apparatus for continuous web media and more particularly relates to a transport system that has reduced sensitivity to irregularity in edge characteristics of a continuous web of media.

### BACKGROUND OF THE INVENTION

Continuous web printing allows economical, high-speed, high-volume print reproduction. In this type of printing, a continuous web of paper or other substrate material is fed past one or more printing subsystems that form images by applying one or more colorants onto the substrate surface. In a conventional web-fed rotary press, for example, a web substrate is fed through one or more impression cylinders that perform contact printing, transferring ink from an imaging roller onto the web in a continuous manner.

Proper registration of the substrate to the printing device is of considerable importance in print reproduction, particularly where multiple colors are used in four-color printing and similar applications. Conventional web transport systems in today's commercial offset printers address the problem of web registration with high-precision alignment of machine elements and servo controlled web steering mechanisms. Typical of conventional web handling subsystems are heavy frame structures, precision-designed components, and complex and costly alignment procedures for precisely adjusting substrate transport between components and subsystems.

The problem of maintaining precise and repeatable web registration and transport becomes even more acute with the development of high-resolution non-contact printing, such as high-volume inkjet printing. With this type of printing system, finely controlled dots of ink are rapidly and accurately propelled from the printhead onto the surface of the moving media, with the web substrate often coursing past the printhead at speeds measured in hundreds of feet per minute. No impression roller is used; synchronization and timing are employed to determine the sequencing of colorant application to the moving media. With dot resolution of 600 dots-per-inch (DPI) and better, a high degree of registration accuracy is needed. During printing, variable amounts of ink may be applied to different portions of the rapidly moving web, with drying mechanisms typically employed after each printhead or bank of printheads. Variability in ink or other liquid amounts and types and in drying time can cause substrate stiffness and tension characteristics to vary dynamically over a range for different types of substrate, contributing to the overall complexity of the substrate handling and registration challenge.

One approach to the registration problem is to provide a print module that forces the web media along a tightly controlled print path. This is the approach that is exemplified in U.S. Patent Application No. 2009/0122126 entitled “Web Flow Path” by Ray et al. In such a system, there are multiple drive rollers that fix and constrain the web media position as it moves past one or more ink application printheads. Problems with such a conventional approach include significant cost in design, assembly, and adjustment and alignment of web handling components along the media path.

Various approaches to web tracking are suitable for various printing technologies. For example, active alignment steering, as taught for an electrographic reproduction web (often referred to as a belt on which images are transported) in commonly assigned U.S. Pat. No. 4,572,417 entitled “Web Tracking Apparatus” to Joseph et al. would be difficult and costly to employ such a solution with a print medium whose stiffness and tension vary during printing, and whose edge irregularities are of a much greater magnitude than that found on web belts, as described in the reference cited above. Other solutions for web (or belt as referred to above) steering are similarly intended for endless webs in Electrophotographic equipment but are not readily adaptable for use with paper media. Steering using a surface-contacting roller, useful for low-speed photographic printers and taught in commonly assigned U.S. Pat. No. 4,795,070 entitled “Web Tracking Apparatus” to Blanding et al. would be inappropriate for a surface that is variably wetted with ink and would also tend to introduce non-uniform tension in the cross-track direction. Other solutions taught for photographic media, such as those disclosed in commonly assigned U.S. Pat. No. 4,901,903 entitled “Web Guiding Apparatus” to Blanding are well suited to photographic media moving at slow to moderate speeds but are inappropriate for systems that need to accommodate a wide range of medias, each with different characteristics, and transport each media type at speeds of hundreds of feet per minute.

In order for high-speed non-contact printers to compete against earlier types of devices in the commercial printing market, the high cost of the web transport should be greatly reduced. As such, there is a need for an adaptable non-contact printing system that can be fabricated and configured without the cost of significant down-time, complex adjustment, and constraint on web media materials and types.

Additionally, in order to provide registration accuracy for a continuous web media transport system, proper edge guidance is important. An edge guide establishes the lateral position of the web media for such a system. The combination of edge guidance with suitable angular constraint for the moving web allows kinematic principles, or “exact constraint” to be applied to the transport problem, helping to minimize the need for complex web handling apparatus and minimize the likelihood of inducing undesirable stress or constraint in the web handling mechanics.

One problem with continuous kinematic web media handling, however, relates to edge defects. The edge of the web that requires guidance may have various types of defects due to mishandling, slitting operation variability during manufacture and consequent edge weave, splicing, and other causes. These edge defects, inherent to large rolls of printing paper, for example, make it difficult to rely on a single edge guide for maintaining proper registration, particularly needed when printing multiple color separations. Mis-registration in the printing area is likely, since the lateral motion of the web media is dependent on the quality and straightness of the media edge.

One way of addressing this problem has been the use of web steering techniques, using a servo motor with a steering roller and employing a i“deadband” that filters out some high-frequency web edge effects. This is the approach used, for example, for an electrophotographic belt transport in commonly assigned U.S. Pat. No. 4,572,417 entitled “Web Tracking Apparatus” to Joseph et al. While this type of active control approach using a servo can be appropriate for a closed-loop transport belt, however, the problems presented by a continuous web of print media moving at high speeds are more acute, particularly since the edge of the web itself is used to maintain register accurately.

### SUMMARY OF THE INVENTION

It is an object of the present invention to advance the art of continuous web media handling for printing and other applications. With this object in mind, the present invention provides a digital printing system for printing on a continuous web of print media. The media transport system of the printing system includes a support structure that guides a continuous web of print media under tension through the printing system. The support structure includes a first mechanism, a roller, and a section in which cross track motion of the continuous web of print media is not desired. The first mechanism is affixed to the support structure and includes structure that positions the print media in a cross track direction. The roller is affixed to the support structure and sets an angular trajectory of the print media. The roller is located downstream relative to the first mechanism. The section in which cross track motion of the continuous web of print media is not desired is located downstream relative to the roller.

According to another feature of the present invention, a digital printing system for printing on a continuous web of print media includes a support structure that guides a continuous web of print media under tension through the printing system. The continuous web of print media includes an edge. The support structure includes a first mechanism, a filter mechanism, and a section in which cross track motion of the continuous web of print media is not desired. The first mechanism is affixed to the support structure and includes structure that positions the print media in a cross track direction. The filter mechanism sets an angular trajectory of the print media, is located downstream relative to the first mechanism, and passively filters fluctuations in position of the edge of the continuous web of print media. The section in which cross track motion of the continuous web of print media is not desired is located downstream relative to the filter mechanism.

According to another feature of the present invention, a method of transporting a continuous web of print media through a digital printing system includes guiding a continuous web of print media under tension along a media path of the printing system, the continuous web of print media including an edge; positioning the print media in a cross track direction at a first location along the media path; establishing an angular trajectory of the print media at a second location of the media path after positioning the print media in the cross track direction to passively filter fluctuations in position of the edge of the print media and to define the cross track position of the print media at the second location of the media path, the second location being at a distance downstream from the first location; and causing the print media to travel through a section of the media path in which cross track motion of the print media is not desired after passively filtering fluctuations in position of the edge of the print media at the second location of the media path.

One advantage of the present invention is that it reduces or eliminates the negative impact of web edge defects on registration in a web transport apparatus. The present invention is compatible with kinematic design principles, supporting a web transport system in which components self-align to the continuously moving web in order to maintain excellent web tracking performance without precise alignment of the web transport components and in order to maintain accurate registration of the printing media. Another advantage of the present invention is that it allows non-contact printing, or, more generally, the application of fluid, onto the media surface at high speeds, without applying an over-constraining force or pressure that might inadvertently damage the media, cause image misregistration, or otherwise inhibit proper transport of the media web.

The apparatus and methods of the present invention improve overall print quality by allowing more consistent color to color registration on print media and more consistent inspection capability for verification and color control throughout a print job.

The invention and its objects and advantages will become more apparent in the detailed description of the example embodiments presented below. The invention is defined by the claims.

### BRIEF DESCRIPTION OF THE DRAWINGS

In the detailed description of the example embodiments of the invention presented below, reference is made to the accompanying drawings, in which:

FIG. 1 is a schematic side view of a digital printing system according to an example embodiment of the present invention;

FIG. 2A is a perspective view showing an orthogonal coordinate system used to characterize web media constraints;

FIG. 2B is a schematic top view showing angular and lateral constraints applied to a continuously moving web;

FIG. 3 is a plan view showing some of the more noticeable types of defects of the web edge;

FIG. 4 is a schematic view showing parameters for utilizing the filter transfer function of a web span;

FIG. 5 is a graph showing the frequency response of a web span that has a roller for angular constraint;

FIG. 6A is a schematic view showing the use of cascaded web spans as cascaded low-pass filters;

FIG. 6B is a graph showing the attenuation increase when using multiple web spans;

FIG. 7 is an enlarged schematic side view of a digital printing system according to an example embodiment of the present invention;

FIG. 8 is a web plane diagram that shows schematically where various constraints are imposed along the media path shown in the side view of FIG. 7;

FIG. 9A shows a web plane diagram and its corresponding filter transform sequence;

FIG. 9B shows the web plan diagram portion of FIG. 9A with a centerline superimposed;

FIG. 10 is a graph showing system response to edge weave;

FIG. 11 is a graph showing system response to edge damage; and

FIG. 12 is a graph showing system response to a splice step.

### DETAILED DESCRIPTION OF THE INVENTION

The present description will be directed in particular to elements forming part of, or cooperating more directly with, apparatus in accordance with the present invention. It is to be understood that elements not specifically shown or described may take various forms well known to those skilled in the art.

The method and apparatus of the present invention utilize features and principles of exact constraint for transporting continuously moving web print media past one or more digital printheads, such as inkjet printheads. The apparatus and method of the present invention are particularly well suited for printing apparatus that provide non-contact application of ink or other colorant onto a continuously moving medium. The printhead of the present invention selectively moistens at least some portion of the media as it courses through the printing system, but without the need to make contact with the print media.

In the context of the present disclosure, the term “continuous web of print media” relates to a print media that is in the form of a continuous strip of media as it passes through the printing system from an entrance to an exit thereof. The continuous web of print media itself serves as the receiving print medium to which one or more printing ink or inks or other coating liquids are applied in non-contact fashion. This is distinguished from various types of “continuous webs” or “belts” that are actually transport system components rather than receiving print media and that are typically used to transport a cut sheet medium in an electrophotographic or other printing system. The terms “upstream” and “downstream” are terms of art referring to relative positions along the transport path of a moving web; points on the web move from upstream to downstream. Where used relative to the web path, the term “after” means occurring downstream or at a position later in the paper path. When used in this context, the term “after” does not necessarily imply that the cross track positioning has ended, been stopped, or temporarily discontinued.

A fixed roller is non-pivotable and may or may not be a drive roller. The fixed roller may spin on its axis, but is not movable in other directions.

Kinematic web handling is provided throughout the web transport apparatus of the printing system of the present invention as the continuously moving web medium passes from one portion of the system to another. In doing this, the apparatus and methods of the present invention adapt a number of exact constraint principles to the problem of web handling. As part of this adaptation, the inventors have identified ways to allow the moving web to maintain proper cross-track registration in a “passive” manner, with a measure of self-correction for web alignment. Steering of the web is avoided unless absolutely necessary; instead, the web's lateral and angular positions in the plane of transport are exactly constrained. Moreover, other web support devices used in transporting the web, other than non-rotating surfaces or those devices purposefully used to exactly constrain the web, are allowed to self-align with the web. The digital printing system according to this invention includes one or more modules that guide the web of print media as it passes at least one non-contact digital printhead. The digital printing system can also include components for drying or curing of the printing fluid on the media; for inspection of the media, for example, to monitor and control print quality; and various other functions. The digital printing system receives the print media from a media source, and after acting on the print media conveys it to a media receiving unit. The print media is maintained under tension as it passes through the digital printing system, but it is not under tension as it is received from the media source.

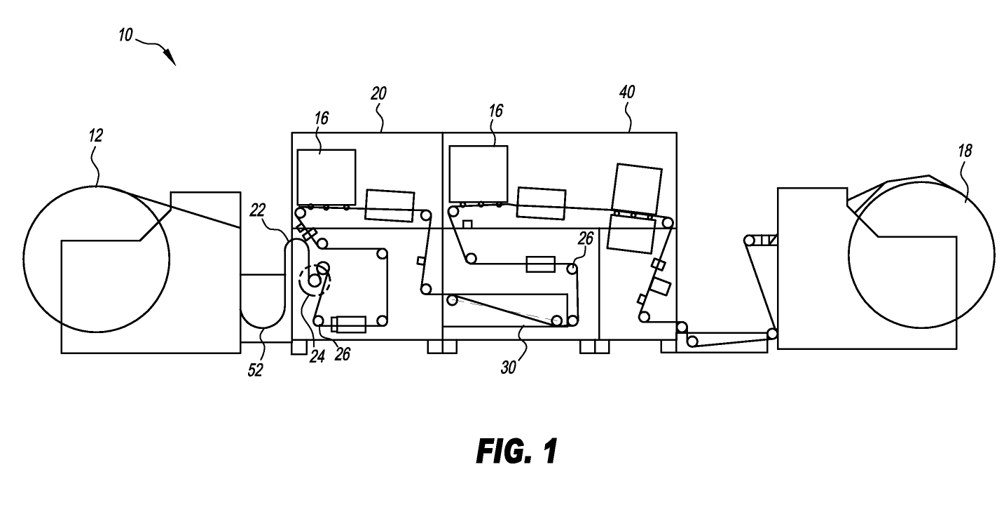

Referring to the schematic side view of FIG. 1, there is shown a digital printing system 10 for continuous web printing according to one embodiment. A first module 20 and a second module 40 are provided for guiding continuous web media that originates from a source roller 12. Following an initial slack loop 52, the media that is fed from source roller 12 is then directed through digital printing system 10, past one or more digital printheads 16 and supporting printing system 10 components. Printheads 16 are configured to selectively moisten at least a portion of the print media without contacting the print media. In the vicinity of digital printheads 16, cross-track motion of the continuous web media is highly undesirable. First module 20 has a support structure, shown in more detail subsequently, that includes a cross-track positioning mechanism 22 for positioning the continuously moving web of print media in the cross-track direction, that is, orthogonal to the direction of travel and in the plane of travel. In one embodiment, cross-track positioning mechanism 22 is an edge guide for registering an edge of the moving media. A tensioning mechanism 24, affixed to the support structure of first module 20, includes structure that sets the tension of the print media.

Downstream from first module 20 along the path of the continuous web media, second module 40 also has a support structure, similar to the support structure for first module 20. Affixed to the support structure of either or both the first or second module 20 or 40 is a kinematic connection mechanism that maintains the kinematic dynamics of the continuous web of print media in traveling from the first module 20 into the second module 40. Also affixed to the support structure of either the first or second module 20 or 40 are one or more angular constraint structures 26 for setting an angular trajectory of the web media.

Still referring to FIG. 1, printing system 10 optionally also includes a turnover mechanism 30 that is configured to turn the media over, flipping it backside-up in order to allow printing on the reverse side. The print media then leaves the digital printing system 10 and travels to a media receiving unit, in this case a take-up roll 18. A take-up roll 18 is then formed, rewound from the printed web media. The digital printing system can include a number of other components, including multiple print heads and dryers, for example, as described in more detail subsequently. Other examples of system components include web cleaners, web tension sensors, and quality control sensors.

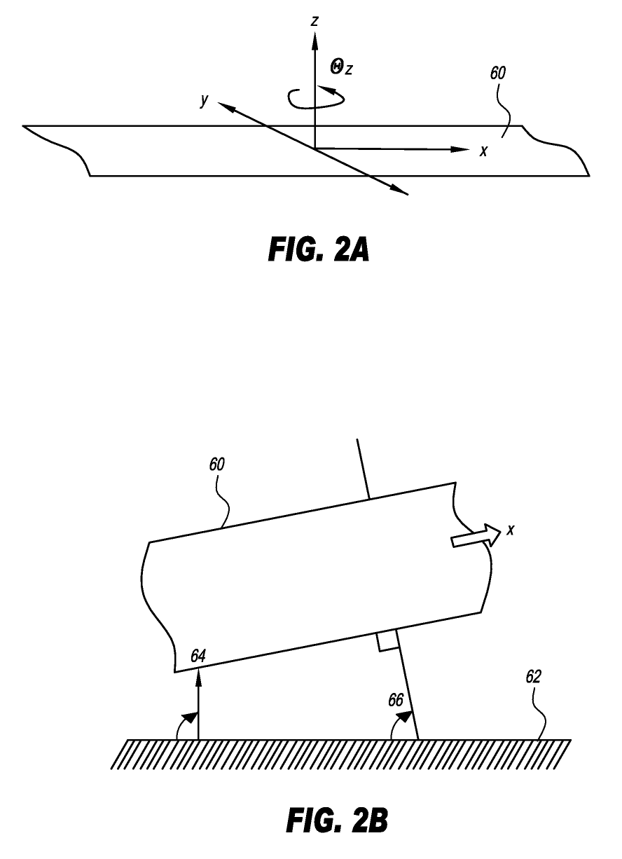

FIG. 2A shows a perspective view of a portion of the web path with orthogonal coordinates used herein to describe principles of web constraint. A moving web 60 is considered to be unconstrained in the x direction. Cross-track y direction is considered orthogonal to the x direction. Angular trajectory is described in terms of Θz, rotation about the orthogonal z axis.

FIG. 2B shows, in a schematic top view, symbols for exact constraint principles that are applied to a continuously moving web and are used for the apparatus and methods of the present invention. This type of drawing is commonly referred to as a web plane diagram. In FIG. 2A, the constraints that are applied over and define a single web span are shown. Moving web 60 is shown deliberately skewed with respect to the web support structure 62. A lateral constraint is denoted by an arrow from the web support structure 62 that contacts the edge of the moving web as shown at 64. An angular constraint that defines the downstream edge of the web span is denoted by a solid line from the web support structure 62 that spans the web and is perpendicular to the web shown at 66. A support that provides no lateral or angular constraint on the web passing over it is denoted by a dashed line from the web support structure 62 that crosses the web at a non-perpendicular angle, as shown in subsequent web plane diagrams. This figure shows a combination of an upstream lateral constraint (64) and a downstream angular constraint (66) that is useful for providing a stable constraint condition for each web span. A number of related principles have also been found useful for maintaining exact constraint and relate to web plane diagramming:

These include the following:
(i) Web 60 tends to approach a roller at a 90 degree angle, as shown in FIG. 2B by the orthogonal symbol along the edge of web 60 at angular constraint 66.
(ii) Stationary curved surfaces impart no measurable cross-track force onto a moving web passing over it, and can be denoted by a dashed line.
(iii) Castered rollers allow the roller to rotate so that it is at a 90 degree angle to the approaching web. These also can be denoted in the web plane diagram as a dashed line.
(iii) Gimbaled rollers allow the web to maintain its preferred 90 degree angle approach and orientation to the next downstream roller along the web path. This is because the web exhibits considerable flexibility in twist. Since the gimbaled roller provides the flexibility needed for the web to align with the following roller, they are illustrated in web plane diagrams as a pivot allowing adjacent spans to have differing angles relative to the web support structure. At the same time, gimbaled rollers can be used to provide an angular constraint as the web approaches the gimbaled roller at a 90 degree angle.
(iv) Castered rollers can be used where it is desirable to impart no lateral or angular constraint to the moving web.
(v) Two edge guides within the same web span provide both lateral and angular constraint.

Within the printing apparatus of the present invention, the web is guided along its transport path through a number of rollers and curved surfaces.

For each web span, both lateral constraint 64 and angular constraint 66 are necessary. However, adding an additional mechanism to achieve lateral or angular constraint can easily cause an over-constraint condition. Thus, for each web span that follows an initial lateral constraint along the web path, the constraint method employed by the inventors attempts to use, as its lateral “constraint”, the given cross track position of the web as it is received from the preceding web span.

Over each web span, then, an angular constraint is provided by a roller mechanism, as described in more detail subsequently. Not every roller along the web path applies angular constraint; in many cases it is advantageous to provide a castered roller or a stationary curved surface that is arranged to provide zero constraint.

Following principles such as these, the inventors have found that an arrangement of mechanisms can be provided to yield the stable constraint arrangement described with respect to FIG. 2B over each web span, so that web 60 itself maintains lateral position without external steering or other applied force. In addition, these same mechanisms operable at the interface of one web span to the next also apply at the interface as the web passes between one module and the next.

It is important to maintain the center-line of the moving web at the same relative position along each roller, regardless of edge defects in order to maintain accurate registration, for example, color registration during printing. Even with edge guide alignment, center-line registration should be maintained. Subsequent figures and description show how center-line registration applies along the path of the web media.

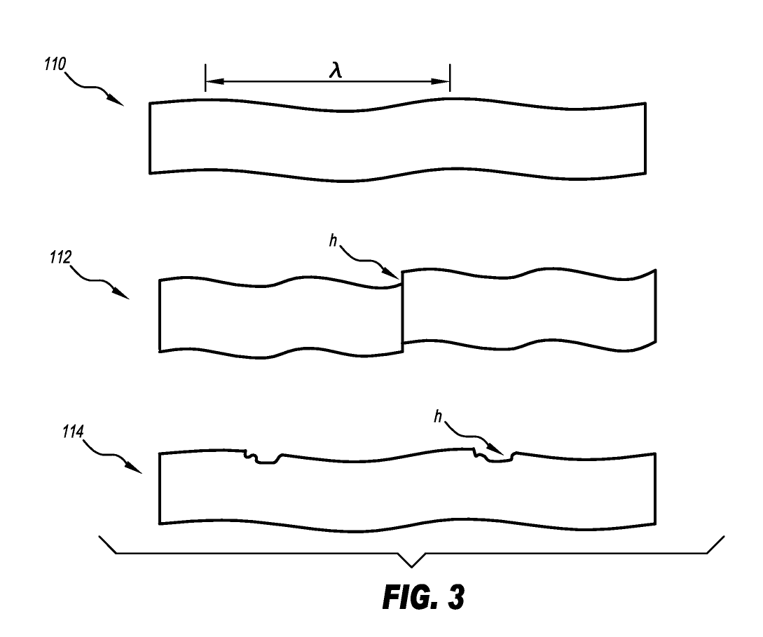

As noted earlier in the background section, the task of providing a lateral constraint along the edge of the moving web is complicated by irregularities in the web edge, either inherent to the slitting and manufacturing process for the roll of media or due to stacking or handling problems. The plan views of FIG. 3 show some of the more noticeable types of defects of the web edge and show some parameters useful in describing how embodiments of the present invention tackle these problems. The particular edge irregularities noted in FIG. 3 are the following:
(i) Edge weave 110. This periodic or quasi-periodic defect is often caused by the slitting operation in manufacture of the web media roll. A similar effect can also be due to supply roll runout. This defect has a characteristic length λ.
(ii) Step 112. This defect may or may not be periodic or quasi-periodic but relates to a misaligned splice along the web. Step magnitude is designated h.
(iii) Indentation defect 114. Damage in handling the roll, such as during shipping or stacking, can cause quasi-periodic indentations. This defect type is similar to step 112 and has a height magnitude h, but is generally of short duration and quasi-periodic.

For web transport systems that incorporate and edge guide to set the lateral position of the web, the crosstrack motion of the web's centerline will typically follow the irregularities of the web's edge. It can be readily appreciated that some type of compensation is needed in order to limit the effects of each of the types of edge irregularities shown in FIG. 3. Whether periodic, quasi-periodic, or non-periodic, edge defects of the types shown could adversely affect web registration where edge guidance is used. Inaccurate registration would make it difficult to print multiple colors with proper superimposition, for example. Example embodiments of the present invention address this problem by applying principles adapted from signal filtering. To do this, the web span, introduced in FIG. 2B, is configured to behave as a low-pass filter, attenuating high-frequency edge defects in a passive manner, while maintaining kinematic web handling and conforming to exact constraint principles.

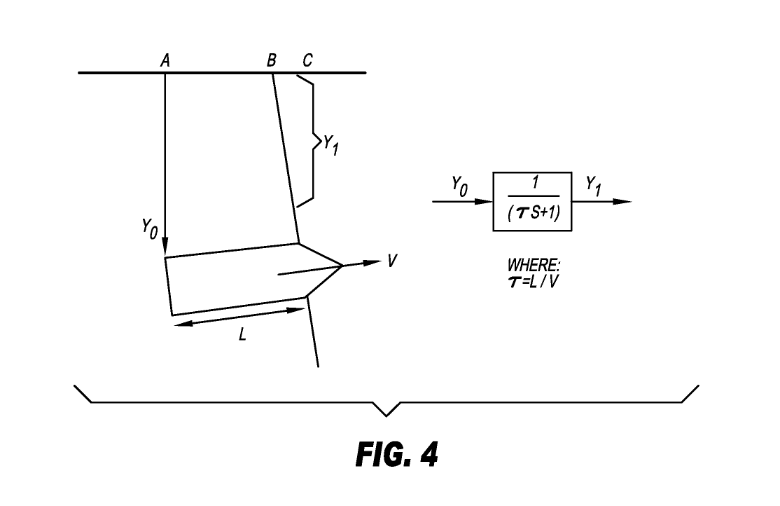

Referring to the schematic diagram of FIG. 4, parameters that are useful for analyzing and utilizing the filter transfer function of a web span are shown. The inventors have found that where a web span has a roller that sets an angular trajectory and thus acts as an angular constraint, such as roller B in the web span diagram shown, and that has it's upstream lateral position determined by an edge guide such as lateral constraint A in the web span diagram shown, or that has it's upstream lateral positioned determined by the preceding web span, that the web span has the transfer function of a low-pass filter (LPF).

Shown on the right side of FIG. 4 is the web span transfer function, in a format familiar to those skilled in analysis of signal-handling systems, in which components are idealized according to a first-order transfer function that is obtained using the Laplace transform. For the transfer function shown, parameter τ is the ratio of span length L to web media velocity V, and s is the Laplace transform operator. Parameters y₀ and y₁ are input and output values relative to the web span transfer function shown and are the crosstrack position of the web's centerline at the input and output of that span.

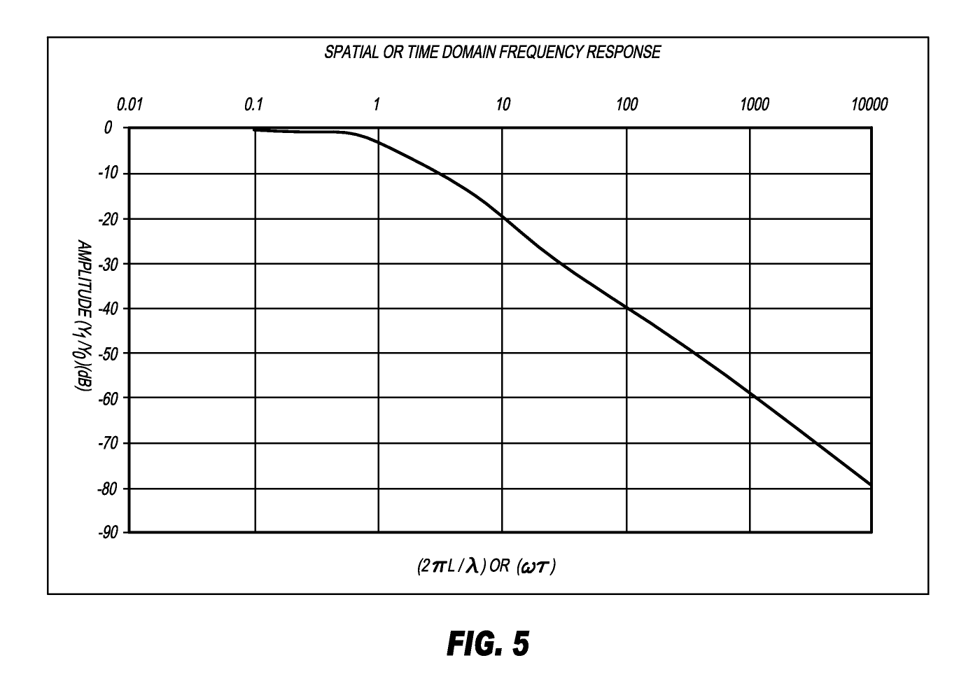

The graph of FIG. 5 shows, for a typical web span, the amplitude of low-pass filter attenuation, in decibels (dB), in both spatial and time domains. The variable ω is used to relate attenuation to the frequency of the input, in this case the frequency of the edge irregularity in radians per second. As this graph shows, the first order transfer function for the web span provides an attenuation of 20 dB per decade.

Span length relates to the distance between the angular constraint and the location where the upstream lateral position of that span is determined. In terms of spatial frequency, where the span length L equals or exceeds 16% (½π) of the period λ of the defect, attenuation caused by the web span is significant. For example, approximately 16 dB attenuation is provided when the span length L is about the same as the characteristic length λ of the defect. An attenuation of 16 dB results in reducing the centerline motion due to web edge irregularity by approximately 85%. As a practical minimum for providing the passive filtering of the present invention, the span length should be at least greater than about 0.13 times the characteristic length, and preferably greater than the characteristic length for effective filtering of a periodic defect in the print media, for example, an edge weave 110. A span length of at least 0.13 times the characteristic length reduces the centerline motion due to web edge irregularity by approximately 20%. However, span lengths that are less than 0.13 times the characteristic length still filter periodic and quasi-period defects, for example, indentation defects 114, or non-periodic defects such as step defects 112. At the other extreme, practical considerations such as maintaining cross-track stiffness of the web in the span may place some limits on the maximum length of a web span.

It should be noted that a span can be folded over a surface, for example; span length refers to the actual distance traveled by the media and does not necessarily correspond to the linear distance between the angular constraint roller and the location where the upstream lateral position of that span is determined. Even though it is generally preferable to have a span length that is greater than the characteristic length of the periodic irregularity, a span length that is less than the characteristic length will filter the irregularity, although the amount of filtering will be less. As such, when the span length is less than the characteristic length of the irregularity, it can be particularly useful and desirable to provide more filter mechanisms.

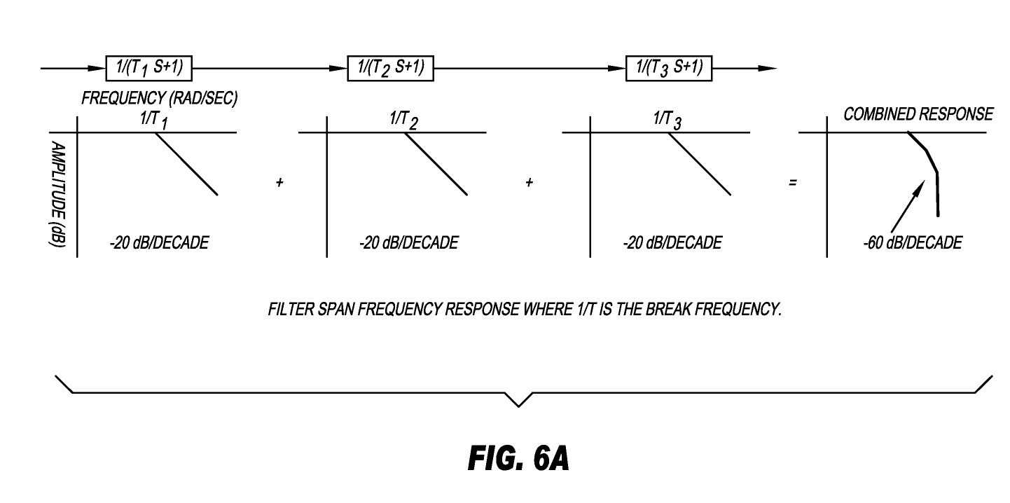

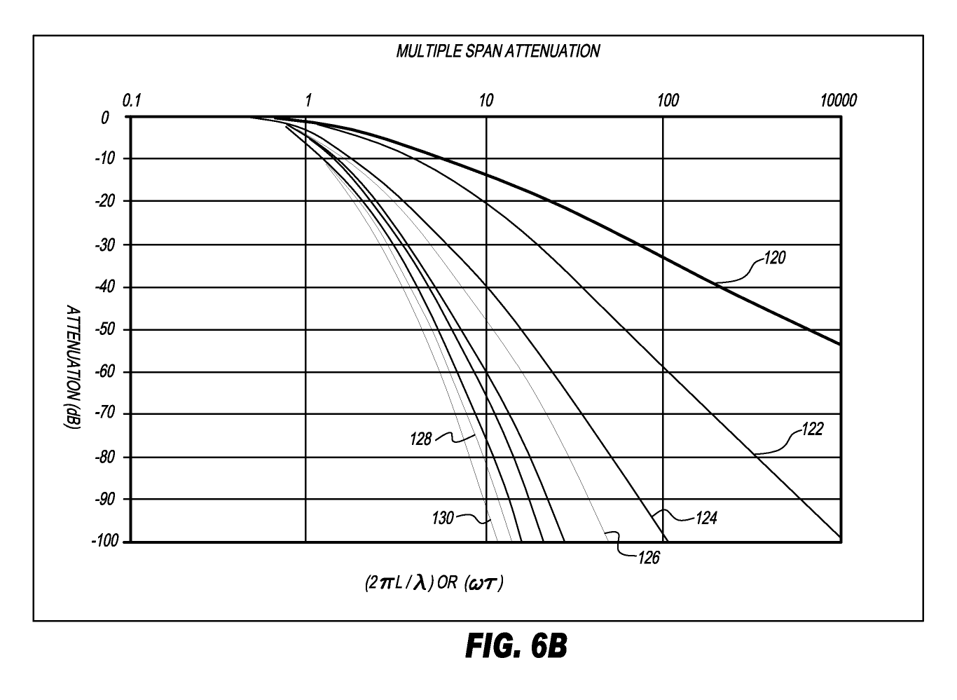

The passive filtering effect of the web span is further improved by cascading. Referring to the schematic diagram of FIG. 6A, there are shown the transfer functions for a series of cascaded low-pass filters. With cascaded filters and using the Laplacian transfer function representation, the multiplicative effect of cascading can be seen. Below each transfer function is a graph of its corresponding attenuation characteristic in Bode plot format, showing that each web span, when deployed as a type of low-pass filter, increases the overall attenuation of edge defects by 20 dB per decade. The combined response is shown at the far right, with 60 dB per decade attenuation applied for the three web spans shown. Recalling that decibels are a log expression, it can be seen that cascading web spans having rollers that act as angular constraints multiplies the attenuation effect of each web span.

The graph of FIG. 6B shows how attenuation is multiplicative and thus becomes more pronounced with multiple spans. A curve 120 shows attenuation for a single span. Curves 122, 124, and 126 show how attenuation increases when cascading two, three, and four spans, respectively. By comparison, curves 128 and 130 show the dramatic attenuation levels achieved cascading eight and nine web spans.

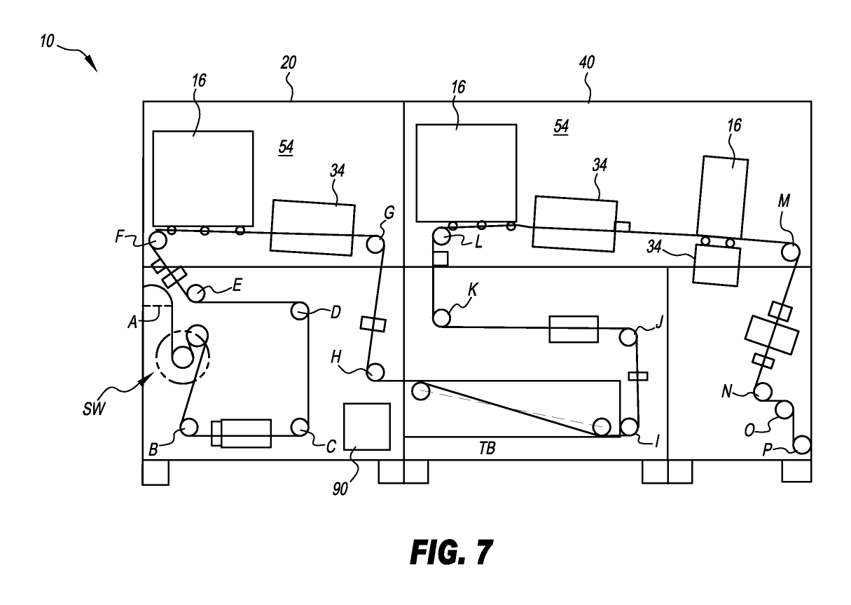

Embodiments of the present invention apply the principles described with reference to FIGS. 4, 5, 6A, and 6B to the problem of reducing, to negligible levels, cross-track motion of the continuous web due to web edge defects. In order to describe this in detail, FIG. 7 and following show an embodiment for a printing system 10 that is configured to print on both sides of a continuous web medium.

The schematic side view diagram of FIG. 7 shows, at enlarged scale from that of FIG. 1, the media routing path through two modules 20 and 40 of printing system 10 in one embodiment. Within each module 20 and 40, in a print zone 54, each print head 16 is followed by a dryer 34. Each module 20 and 40 has a support structure, such as a frame or chassis with its affixed components, that guides the web under tension through printing system 10. Rollers are affixed to the support structure.

Table 1 that follows identifies the lettered components used for web media transport and shown in FIG. 7. An edge guide mechanism, affixed to the support structure, in which the media is pushed laterally so that an edge of the media contacts a stop, is provided at A. The slack web entering the edge guide allows the print media to be shifted laterally without interference and without being overconstrained. An S-wrap device SW provides stationary curved surfaces over which the continuous web slides during transport. As the paper is pulled over these surfaces the friction of the paper across these surfaces produces tension in the print media. In one embodiment, this device allows an adjustment of the positional relationship between surfaces, to control the angle of wrap and allow adjustment of web tension.

TABLE 1
Roller Listing for FIG. 7

| Media Handling | |
|---|---|
| Component | Type of Component |
| A | Lateral constraint (edge guide) |
| SW - S-Wrap | Zero constraint (non-rotating support). |
| | Tensioning. |
| B | Angular constraint (in-feed drive roller) |
| C | Zero constraint (Castered and Gimbaled Roller) |
| D* | Angular constraint with hinge (Gimbaled Roller) |
| E | Angular constraint with hinge (Gimbaled Roller) |
| F | Angular constraint (Fixed Roller) |
| G | Zero constraint (Castered and Gimbaled Roller) |
| H | Angular constraint with hinge (Gimbaled Roller) |
| TB (TURNOVER) | Angular constraint |
| I | Zero constraint (Castered and Gimbaled Roller) |
| J* | Angular constraint with hinge (Gimbaled Roller) |
| K | Angular constraint with hinge (Gimbaled Roller) |
| L | Angular constraint (Fixed Roller) |
| M | Zero constraint (Castered and Gimbaled Roller) |
| N | Angular constraint (out-feed drive roller) |
| O | Zero constraint (Castered and Gimbaled Roller) |
| P | Angular constraint with hinge (Gimbaled Roller) |

Note:
Asterisk (*) indicates locations of load cells.

The first angular constraint is provided by in-feed drive roller B in the embodiment of FIG. 7. This is a fixed roller that cooperates with a drive roller in the turnover section and with an out-feed drive roller N in second module 40 in order to move the web through the printing system with suitable tension in the movement direction (x-direction). The tension provided by the preceding S-wrap serves to hold the paper against the in-feed drive roll so that a nip roller is not required at the drive roller. Angular constraints at subsequent locations downstream along the web are often provided by rollers that are gimbaled so as not to impose an angular constraint on the next downstream web span.

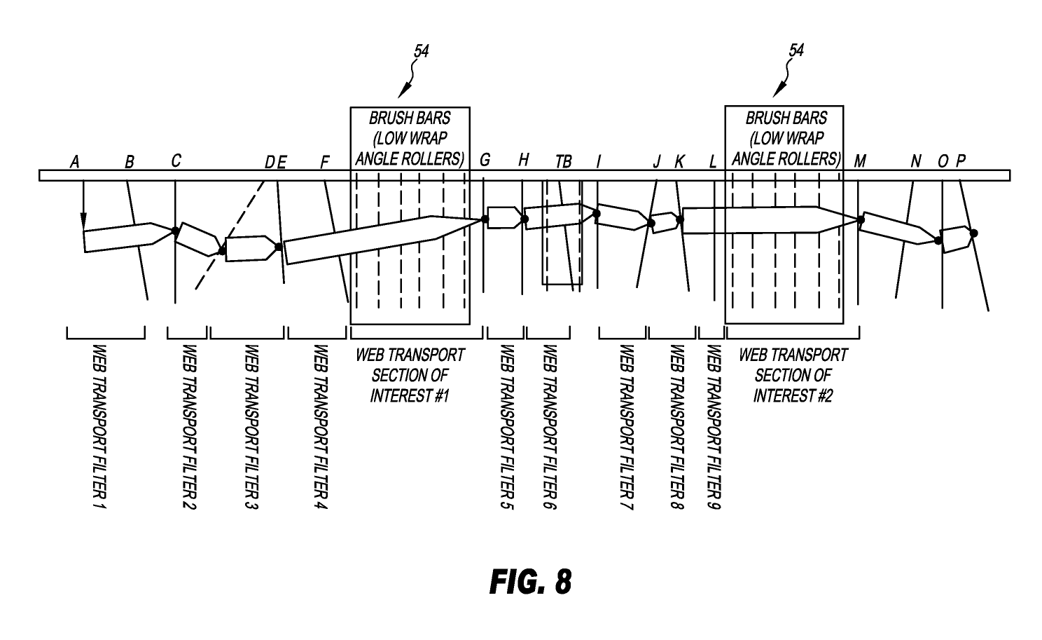

The web plane diagram of FIG. 8 schematically shows where various constraints are imposed at different locations along the media path shown in the side view of FIG. 7. The following notes help to interpret the diagram of FIG. 8 and to relate this schematic representation to the component arrangement shown in FIG. 7:
(i) There is a single lateral constraint mechanism used at A at the beginning of the media path that is sufficient for establishing the lateral position of the web as it enters the first module 20. It is significant that only one lateral constraint is actively applied throughout the media path, here, as an edge guide. However, given this lateral constraint and the following angular constraint, the lateral position at the entrance of the subsequent web span is determined. The angular constraint of that subsequent web span then determines the lateral position at the entrance of the web span immediately downstream from the previous web span. This is repeated throughout the remainder of the media path. In one embodiment, a gentle additional force is applied along the cross-track direction at the edge guide as an aid for urging the media edge against the edge guide at A. This force is often referred to as a nesting force as the force helps cause the edge of the media to nest along side the edge guide. A suitable edge guide is described in commonly-assigned copending U.S. patent application Ser. No. ______ (Docket 95525) filed ______, entitled “EDGE GUIDE FOR MEDIA TRANSPORT SYSTEM”, by Christopher M. Muir et al.
(ii) Angular constraints are imposed onto the web path wherever there are solid lines shown across the web in the web plane diagram. Each angular constraint sets the angular trajectory of the web as it moves along. However, the web is not otherwise steered in the embodiment shown.
(iii) Fixed rollers at F and L precede the printheads for each module, providing the desired angular constraint to the web in the print zone. These rollers provide a suitable location of mounting an encoder for monitoring the motion of the media through the printing system.
(iv) Under the printheads, the print media is supported by fixed non-rotating supports. These supports provide zero constraint to the web.
(v) Roller G is a castered and gimbaled roller providing zero constraint. In FIG. 8, dashed lines indicate mechanisms that provide zero constraint, such as where stationary curved surfaces or castered rollers are used.
(vi) Each discrete section between pivots of the web plane diagram represents a web span. As noted, in the recommended practice for exact constraint web handling design, each web span should align properly if it has exactly one lateral and one angular constraint. For most of the web spans, the exit lateral position of the previous or nearest upstream web span sets the lateral position of the web at the entrance to the next web span.
(vii) Castered and gimbaled rollers provide zero constraint along the web path. These mechanisms are used, for example, near the input to each module, making each module independent of angular constraints from earlier mechanisms.
(viii) Axially compliant rollers and fixed surfaces could alternately be used where cross-track constraint is undesirable.

Roller C, a castered and gimbaled roller in the embodiment of FIG. 7, does not provide any angular constraint on the continuous web between the web spans that provide web transport filter 1 and web transport filter 2. By being gimbaled, roller C allows the continuous web to align with downstream roller D in the embodiment shown. A fixed gimbaled surface, or a gimbaled axially compliant roller could alternately be used between roller B in web transport filter 1 and roller D in web transport filter 2. Roller F, affixed to the support structure, may be downstream relative to rollers D or E, while upstream relative to web transport section of interest #1 and sets an angular trajectory for the continuous web as it heads toward web transport section of interest #1, the section where crosstrack motion is not desired, for example, a registration span or zone.

FIG. 8 shows how the various web spans cooperate to form cascaded low-pass filters. Each low-pass filter has a roller that provides an angular constraint. Web sections of interest #1 and #2 are printing sections of the media path, each shown as print zone 54, in which cross-track motion of the web print media is not desired. Upstream from web section of interest #1 is the first bank of cascaded web spans that form web transport filters 1 through 4. Upstream from web section of interest #2 is the second bank of cascaded web spans that form web transport filters 5 through 9.

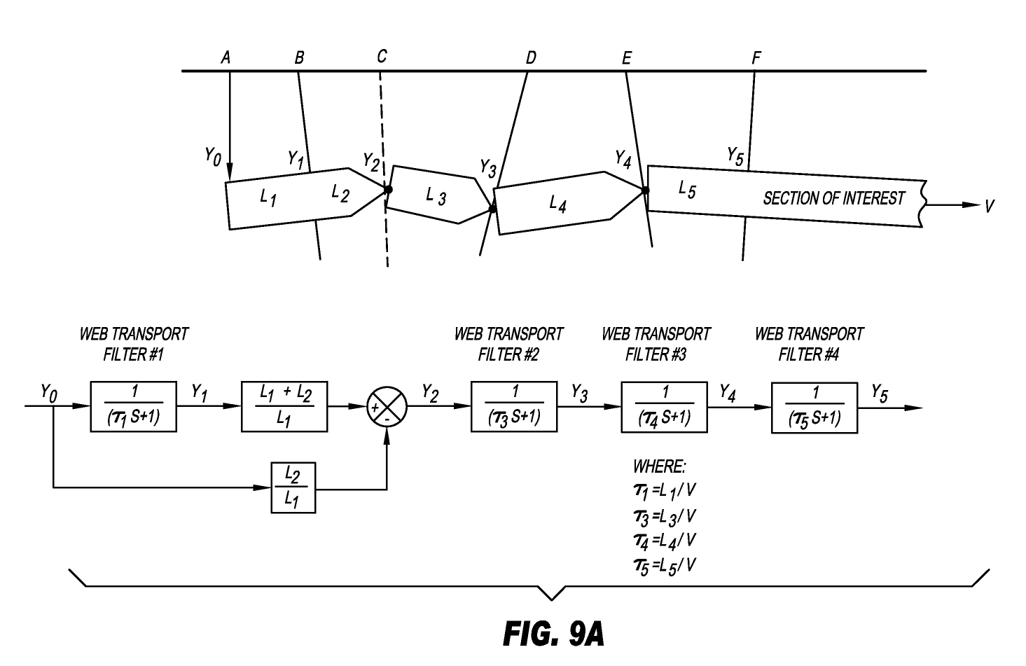

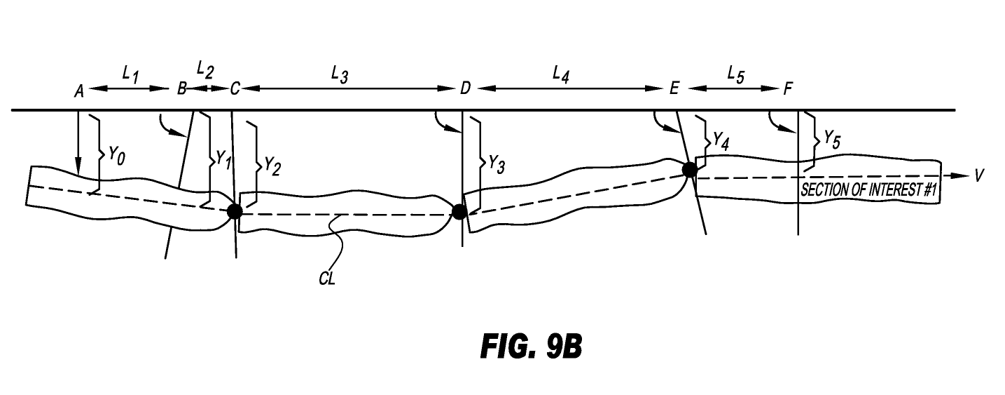

The web plane diagram of FIG. 9A shows the cascaded filter sequence of the first bank of cascaded web spans, the first portion of the media path from FIG. 8, upstream from section of interest #1. In the related diagram of FIG. 9B, the relative positions of a centerline CL, shown as distances y₀ through y₅, reference the web plane diagram portion shown in FIG. 9A.

Segment L2, extending between the angular constraint of roller B and roller C, is an overhang section that contributes an amplification factor to the response of web transport filter 1. As a general observation, an overhang portion that extends beyond the angular constraint in the downstream direction detracts from the filtering function of its web span.

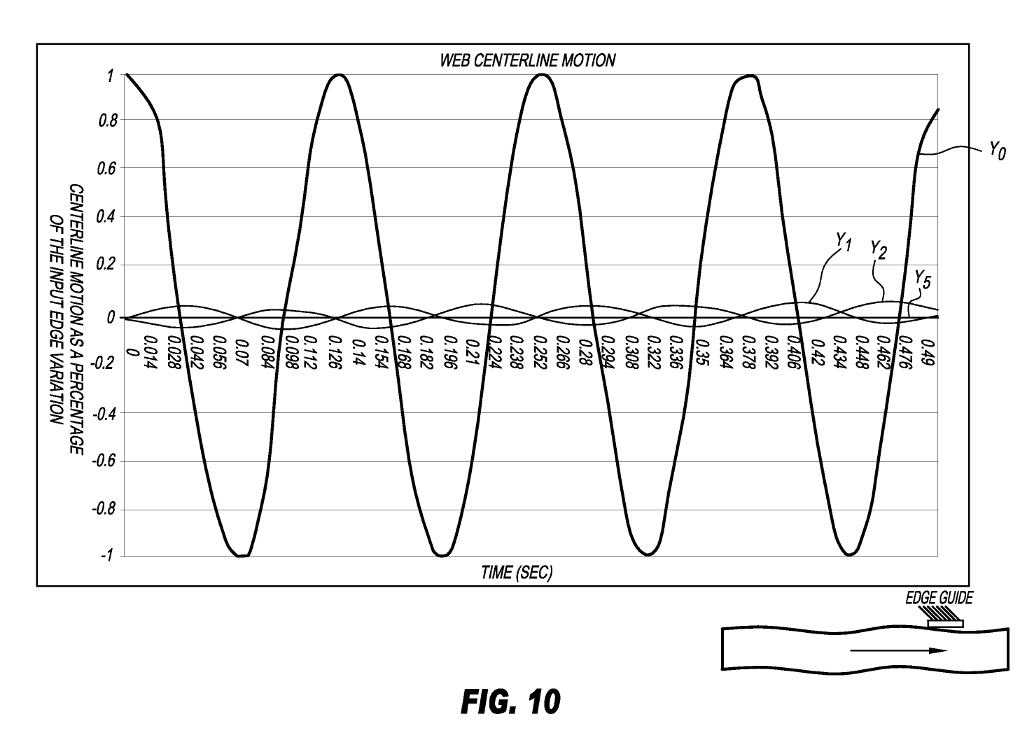

The graph of FIG. 10 shows the system response to edge weave at different points along the web media path. Centerline motion is represented. Designations y₀ and y₅ correspond to those used in the web plane diagram of FIG. 9A and FIG. 9B. There is considerable centerline motion as a percentage of input edge variation at y₀. As can clearly be seen, by position y₅, there is negligible center line motion exhibited along the media path.

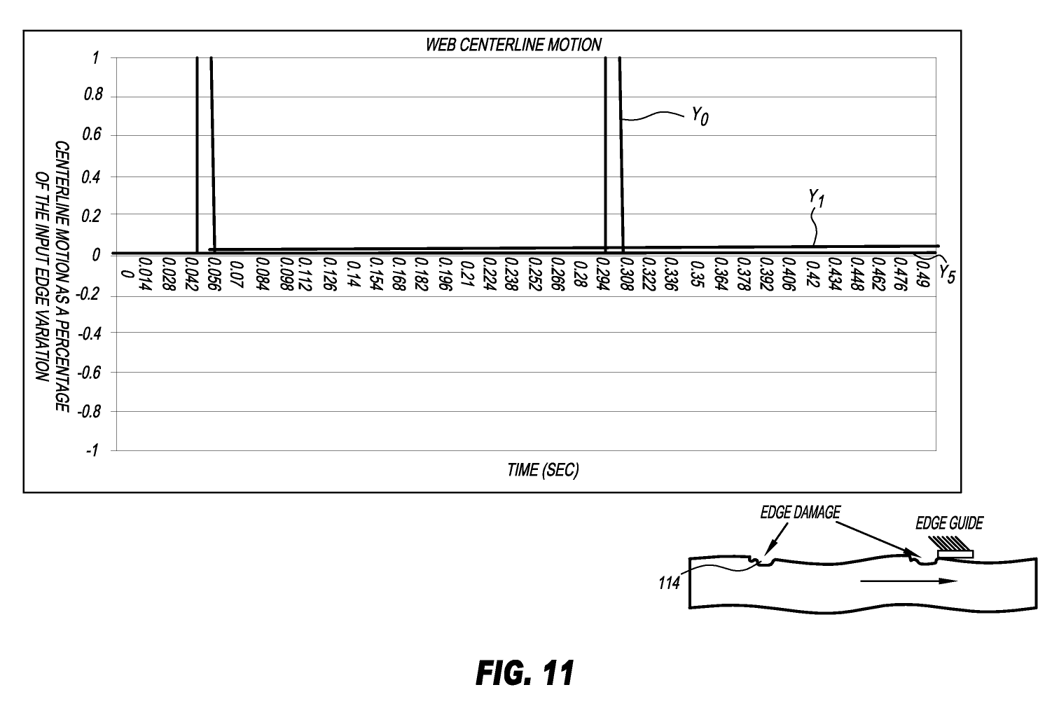

The graph of FIG. 11 shows relative centerline motion for system response to edge damage of indentation defect 114 for the cascaded web spans of FIGS. 9A and 9B. Here again, there is a noticeable impulse measured at position y₀. By the time the web reaches position y₅, there is negligible center line motion exhibited along the media path.

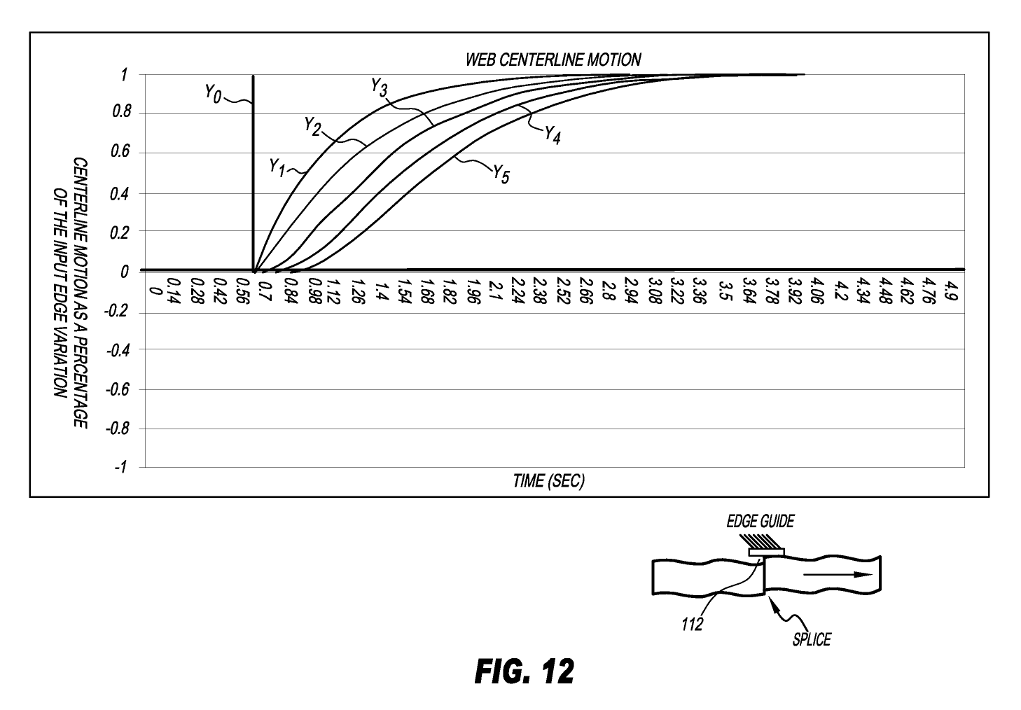

The graph of FIG. 12 shows system response to a splice step 112, showing centerline motion as a percentage of input edge variation for positions y₀, y₁, y₂, y₃, y₄, and y₅. Again, the advantage of cascaded filtering is evident, dampening the effect of splice 112.

The following notes apply for embodiments of the present invention:
(i) In practice, the spacing between filter mechanisms can exceed the characteristic length of the media edge irregularity.
(ii) The embodiment of FIGS. 7 and 8 shows a set of cascaded web transport filters between the first and second print zones 54. However, the second print zone could follow the first print zone, without intermediary web spans for filtering.
(iii) The distance along the media path between a cross-track positioning mechanism and the next downstream roller that sets an angular trajectory can exceed the characteristic length of the irregularity of the edge of the print media.
(iv) Using the arrangement of the present invention, the web spans are not over-constrained. For example, an alternate approach of replacing a filter mechanism with an over constrained set of rollers can cause web to wander and could actually introduce web position irregularity into the web transport system due to stress imposed upon the web.
(v) For indentation defect 114, the dimension of the defect in the length direction is assumed to be longer than the contacting edge of the edge guide. If the indentation defect 114 is shorter than the edge guide, then the edge guide will filter the indentation defect 114.

Advantageously, a passive filter is formed when the web span has the arrangement described, with the roller that sets angular trajectory downstream from the structure that sets cross track position. No additional motors or other actuators are needed to provide the filtering effect.

The digital printing system having one or more printheads that selectively moisten at least a portion of the print media as described above include a media transport system that serves as a support structure to guide the continuous web of print media. The support structure includes an edge guide or other mechanism that positions the print media in the cross track direction. This first mechanism is located upstream of the printheads of the digital printing system. The print media is pulled through the digital printing system by a driven roller that is located downstream of the printheads. The systems also include a mechanism located upstream of printheads of the printing system for establishing and setting the tension of the print media. Typically it is also located downstream of the first mechanism used for positioning the print media in the cross track direction. The transport system also includes a third mechanism to set an angular trajectory of the print media. This can be a fixed roller (for example, a non-pivoting roller) or a second edge guide. However, using a second edge guide will eliminate the filtering effect of that span. The printing system also includes a roller affixed to the support structure, the roller being configured to align to the print media being guided through the printing system without necessarily being aligned to another roller located upstream or downstream relative to the roller. The castered, gimbaled or castered and gimbaled rollers serve in this manner.

As noted earlier, slack loops are not required between or within modules. Slack loops can be appropriate where the continuous web is initially fed from a supply roll or as it is re-wound onto a take-up roll, as was described with reference to the printing apparatus of FIG. 1.

The invention has been described in detail with particular reference to certain preferred embodiments thereof, but it will be understood that variations and modifications can be effected within the scope of the invention.

### PARTS LIST

10. Printing system
12. Source roller
16. Digital printhead
18. Take-up roll
20. Module
22. Cross-track positioning mechanism
24. Tensioning mechanism
26. Constraint structure
28. Support structure
30. Turnover mechanism
32. Drive roller
34, 36. Turn bar
40. Module
48. Support structure
50. Digital printing system
52. Slack loop
54. Print zone
60. Web
62. Edge (support structure)
64. Lateral constraint
66. Angular constraint
110. Edge weave
112. Step
114. Indentation defect
120, 122, 124, 126, 128, 130. Curve
A. Edge guide
B, C, D, E, F, G, H, I, J, K, L, M, N, 0, P. Rollers,
SW. S-wrap
TB. Turnover module
CL. Center line
y₀-y₉. Distance

1. A digital printing system for printing on a continuous web of print media comprising:
a support structure that guides a continuous web of print media under tension through the printing system, the support structure including:
a first mechanism affixed to the support structure, the first mechanism including structure that positions the print media in a cross track direction;
a roller affixed to the support structure that sets an angular trajectory of the print media, the roller being located downstream relative to the first mechanism; and
a section in which cross track motion of the continuous web of print media is not desired, the section being located downstream relative to the roller.

2. The system of claim 1, the print media including a characteristic that is present in a quasi-periodic manner or in a step wise manner, wherein the cross track motion of the continuous web of print media is passively controlled relative to the characteristic of the print media.

3. The system of claim 1, the roller being a first roller, further comprising:
a second roller affixed to the support structure that sets an angular trajectory of the print media, the second roller being located downstream relative to the first roller and upstream relative to the section in which cross track motion of the continuous web of print media is not desired.

4. The system of claim 3, wherein the first roller is a gimbaled roller.

5. The system of claim 3, further comprising:
an element that does not provide an angular constraint on the continuous web of print media located between the first roller and the second roller, the element being gimbaled to allow the continuous web of print media to align with the second roller.

6. The system of claim 3, further comprising:
an element that does not provide an angular constraint on the continuous web of print media located between the second roller and the first roller, the element including one of a castered roller, a fixed surface and an axially compliant roller.

7. The system of claim 3, the roller being a first roller, further comprising:
a third roller affixed to the support structure that sets an angular trajectory of the print media, the at least one additional roller being located downstream relative to the second roller and upstream relative to the section in which cross track motion of the continuous web of print media is not desired.

8. The system of claim 7, wherein the second roller is a gimbaled roller.

9. The system of claim 7, further comprising:
an element that does not provide an angular constraint on the continuous web of print media located between the third roller and the second roller, the element being gimbaled to allow the continuous web of print media to align with the third roller.

10. The system of claim 7, further comprising:
an element that does not provide an angular constraint on the continuous web of print media located between the third roller and the second roller, the element including one of a castered roller, a fixed surface, and an axially compliant roller.

11. The system of claim 1, wherein the section in which cross track motion of the continuous web of print media is not desired includes a print zone including a printhead configured to selectively moisten at least a portion of the print media being guided through the printing system without contacting the print media.

12. A digital printing system for printing on a continuous web of print media comprising:
a support structure that guides a continuous web of print media under tension through the printing system, the continuous web of print media including an edge, the support structure including:
a first mechanism affixed to the support structure, the first mechanism including structure that positions the print media in a cross track direction;
a filter mechanism that sets an angular trajectory of the print media located downstream relative to the first mechanism and passively filters fluctuations in position of the edge of the continuous web of print media; and
a section in which cross track motion of the continuous web of print media is not desired, the section being located downstream relative to the filter mechanism.

13. The system of claim 12, the edge of the print media having an irregularity, the irregularity having a characteristic length, wherein the filter mechanism is spaced apart from the first mechanism by a span length greater than about 0.13 times the characteristic length.

14. The system of claim 12, further comprising:
at least one additional filter mechanism positioned downstream relative to the filter mechanism and upstream relative to the section in which cross track motion of the continuous web of print media is not desired.

15. The system of claim 14, the filter mechanism including a fixed roller, wherein the additional filter mechanism that immediately follows the filter mechanism includes:
a second roller that sets an angular trajectory of the print media; and
an element that does not provide an angular constraint on the continuous web of print media located between the fixed roller and the other roller, the element being gimbaled to allow the continuous web of print media to align with the second roller.

16. The system of claim 15, the edge of the print media having an irregularity, the irregularity having a characteristic length, wherein the additional filter mechanism is spaced apart from the preceding filter mechanism by a span length greater than about 0.13 times the characteristic length.

17. The system of claim 14, the filter mechanism including a gimbaled roller, wherein the additional filter mechanism that immediately follows the filter mechanism includes:
a roller affixed to the support structure that sets an angular trajectory of the print media, the at least one additional roller being located downstream relative to the first roller and upstream relative to the section in which cross track motion of the continuous web of print media is not desired.

18. The system of claim 17, the edge of the print media having an irregularity, the irregularity having a characteristic length, wherein the additional filter mechanism is spaced apart from the preceding filter mechanism by a span length greater than about 0.13 times the characteristic length.

19. The system of claim 12, wherein the section in which cross track motion of the continuous web of print media is not desired includes a print zone including a printhead configured to selectively moisten at least a portion of the print media being guided through the printing system without contacting the print media.

20. The system of claim 12, the section in which cross track motion of the continuous web of print media is not desired being a first print zone, the system comprising:
a second print zone; and
at least one additional filter mechanism positioned between the first print zone and the second print zone.

21. The system of claim 12, the section in which cross track motion of the continuous web of print media is not desired being a first print zone, the system comprising:
a second print zone located downstream relative to the first print zone.

22. A method of transporting a continuous web of print media through a digital printing system comprising:
guiding a continuous web of print media under tension along a media path of the printing system, the continuous web of print media including an edge;
positioning the print media in a cross track direction at a first location along the media path;
establishing an angular trajectory of the print media at a second location of the media path after positioning the print media in the cross track direction to passively filter fluctuations in position of the edge of the print media and to define the cross track position of the print media at the second location of the media path, the second location being at a distance downstream from the first location; and
causing the print media to travel through a section of the media path in which cross track motion of the print media is not desired after passively filtering fluctuations in position of the edge of the print media at the second location of the media path.

23. The method of claim 22, the section of the media path in which cross track motion of the continuous web of print media is not desired including a print zone, further comprising:
selectively moistening at least a portion of the print media using a printhead without contacting the print media with the printhead.

24. The method of claim 22, further comprising:
establishing an angular trajectory of the print media at a third location of the media path to passively filter fluctuations in position of the edge of the print media and to define the cross track position of the print media at a third location of the media path, the third location being at a distance downstream from the second location at which the cross track position of the print media was defined.

25. The method of claim 24, the edge of the print media having an irregularity, the irregularity having a characteristic length, wherein the distance along the media path between the second location and the first location is greater than about 0.13 times the characteristic length of the irregularity of the edge of the print media.

26. The method of claim 25, the distance between the second location and the first location being a first distance along the media path, the second location and the third location being spaced apart from each other by a second distance along the media path, wherein the second distance between the third location and the second location is greater than about 0.13 times the characteristic length of the irregularity of the edge of the print media.

27. The method of claim 24, wherein establishing an angular trajectory of the print media at the third location of the media path occurs after causing the print media to travel through the section of the media path in which cross track motion of the print media is not desired.

28. The method of claim 27, the section of the media path being a first section, the method further comprising:
causing the print media to travel through a second section of the media path in which cross track motion of the print media is not desired after passively filtering fluctuations in position of the edge of the print media at the third location of the media path.

29. The method of claim 28, the second section of the media path in which cross track motion of the continuous web of print media is not desired including a print zone, further comprising:
selectively moistening at least a portion of the print media using a printhead without contacting the print media with the printhead.

30. The method of claim 24, further comprising:
providing an element that does not angularly constrain the print media at a fourth location of the media path that is between the second location of the media path and the third location of the media path, the element being gimbaled to allow the continuous web of print media to align with an element provided at the third location.

31. The method of claim 24, wherein establishing the angular trajectory of the print media at the second location of the media path includes providing an element that is gimbaled to allow the continuous web of print media to align with an element provided at the third location.

32. The method of claim 22, the edge of the print media having an irregularity, the irregularity having a characteristic length, wherein the distance between the second location and the first location is greater than about 0.13 times the characteristic length.

33. The method of claim 22, wherein establishing the angular trajectory of the print media at the second location of the media path includes providing a roller element that is a gimbaled roller or a fixed roller.
